(19) United States
(12) Patent Application Publication
(10) Pub. No.: US 2004/0161310 A1
(43) Pub. Date: Aug. 19, 2004

(54) Rotating cutter head for working the surface of elastomers

(76) Inventors: Dietmar Boxberg, Kurten-Busch (DE); Hans Peter Schnorrenberg, Pulheim (DE)

Correspondence Address: JACOBSON HOLMAN PLLC, 400 SEVENTH STREET N.W., SUITE 600, WASHINGTON, DC, 20004, US

(21) Appl. No.: 10/779,695

(22) Filed: Feb. 18, 2004

Related U.S. Application Data
(63) Continuation of application No. 09/249,087, filed on Feb. 12, 1999, now abandoned.

(30) Foreign Application Priority Data
Feb. 13, 1998 (DE) 298 05 864.1

(51) Int. Cl. B23C 5/00

(52) U.S. Cl. 407/33

(57) ABSTRACT

The rotating cutter head for working the surface of elastomers which comprises indexable inserts or annular cutting tools has said indexable inserts or annular cutting tools provided on the periphery of a disk having a diameter of from 200 to 800 mm, said disk being capable of rotating with up to 5000 revolutions per minute, enabling cutting speeds of from 10 to 100 m/s, preferably from 20 to 60 m/s. At least 6, preferably from 10 to 30, cutting tools are provided on the periphery of said disk.

The present invention relates to a rotating cutter head for working the surface of elastomers which comprises indexable inserts or annular cutting tools.

DE-C-43 05 716 describes the use of a high cycle motor spindle for working the surface of elastomers, wherein the high-speed cutter head rotates with from 5000 to 120,000 rpm around its longitudinal axis, and elastomers having a Shore hardness of 10 Shore A to 100 Shore D are worked on the outer layer of a rotationally symmetrical body. This method mostly works with 25,000 to 30,000 rpm and has proven useful in principle. However, the previously available high cycle motor spindles with high-speed cutter heads are relatively sensitive. The very high revolutions per minute of about 25,000 to 30,000 is accompanied by disagreeable acoustic nuisance. The measures for protection against flying-off and flung-off metal parts in case of a break or destruction of the high-speed cutter heads are very expensive. The wear at the high-speed cutter heads is relatively high. The tool attacks in orthogonal direction since the tool moves axially with respect to the roller.

From EP-A-0 806 260, a method for removing used elastomeric covers from rollers and a device for performing same are known in which not only smooth cutters, but also ground annular cutting tools are used as cutting tools. These annular cutting tools are attached on a cross at the end of the arms of the indexable insert holder. For performing this method, circumferential speeds of the cutting tools of 15 to 70 m/s are employed with from 1500 to 3000 revolutions per minute. The tool attacks in radial direction. The formed shreds of the used covers are relatively large.

It has been the object of the invention to remove the drawbacks of the cutting tools previously used for working the surface of elastomers and to provide rotating cutter heads which are easily handled, safe, have a long service life and reduce the acoustic nuisance (noise pollution).

This object has now been achieved by tools in which the indexable inserts or annular cutting tools are arranged on the periphery of a relatively large disk having a diameter of from 200 to 800 mm, said disk being capable of rotating with up to 5000 revolutions per minute, preferably about 3000 rpm, yet enabling cutting speeds of from 10 to 100 m/s, preferably from 20 to 60 m/s. The tool attacks in radial direction.

In order to enable short working times on such large, but relatively slowly rotating disks, at least 6, preferably from 10 to 30, cutting tools are provided on the periphery of the disks. The high number of the cutting tools, on one hand, and the extended period between two uses of the same cutting tool, on the other hand, result in a clearly prolonged service life and reduce the risk of overheating. The relatively large diameter of the disk in turn allows an essentially more robust design which is not only more stable, but also safer. In addition, such large disks are more easily balanced, which may be necessary after each change of cutting tools already. All in all, such a machine costs only about one eighth of what a machine according to DE-C-43 05 716 costs.

Namely, it is not the revolutions per minute of the cutting tool which is critical to a good cutting performance in the working of elastomers, but its cutting speed. According to the invention, the high cutting speed is enabled by the large diameter at fewer revolutions per minute of up to 5000, preferably about 3000.

While annular cutting tools have been used to date only in small numbers on relatively small indexable inserts and have been employed only for removing used elastomeric covers from rollers, the rotating cutter head according to the invention also allows the working of the surface of elastomers according to DE-C-43 05 716.

Thus, elastomers in the surfaces of rollers in a Shore hardness range of from 10 Shore A to 100 Shore D can be worked, wherein the smaller diameters of the annular cutting tools, on one hand, and low cutting heights and little advance, on the other hand, result in only very small particles being cut from the surface of the elastomer. These small particles are practically powdery and are easily sucked off. Due to the low machining forces, the heat evolution is also very low, and thus the thermal load on the elastomer remaining on the roller is very low. Thus, the rotating cutter head according to the invention allows a rapid and yet very mild working whereby surfaces of the highest quality are produced in one working run. The thus generated surfaces have such a good finish that a grinding aftertreatment can be completely avoided in many cases.

1. A rotating cutter head for working the surface of elastomers which comprises indexable inserts or annular cutting tools, characterized in that said indexable inserts or annular cutting tools are provided on the periphery of a disk having a diameter of from 200 to 800 mm, said disk being capable of rotating with up to 5000 revolutions per minute, enabling cutting speeds of from 10 to 100 m/s, preferably from 20 to 60 m/s.

2. The rotating cutter head according to claim 1, characterized in that the number of said indexable inserts or annular cutting tools on the periphery of said disk is at least 6, preferably from 10 to 30.
